(19) United States
(12) Patent Application Publication
(10) Pub. No.: US 2006/0002126 A1
(43) Pub. Date: Jan. 5, 2006

(54) Vehicular lamp

(75) Inventors: Hiroya Koizumi, Shizuoka (JP); Nobutaka Tezuka, Shizuoka (JP); Hajime Takeda, Shizuoka (JP); Hidenori Suzuki, Shizuoka (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/152,396

(22) Filed: Jun. 14, 2005

(30) Foreign Application Priority Data
Jun. 24, 2004 (JP) 2004-185782

(51) Int. Cl. F21V 1/00

(52) U.S. Cl. 362/509

(57) ABSTRACT

A vehicular lamp including partitions 11 and 12, 13 that demarcate the interior of a lamp chamber 3 defined by a lamp body 1 and an outer lens 2 into a plurality of regions 31 to 33, a light source 62a disposed in at least one of the regions, an inner lens 5 provided to cover the partitions, a means for guiding a part of the light emitted from the light source 62a into the inner lens 5. In addition to one region demarcated by the partitions is brought into a lit state by light directly emitted from the light source 62a, the inner lens 5 is lit by the light from the light source 62a that is guided into and radiates from the inner lens surface.

### BACKGROUND OF THE INVENTION

1. Technical Field

The present invention relates to a vehicular lamp having improved appearance or visibility and a novel external appearance.

2. Description of the Related Art

Vehicular lamps used as marker lamps are installed in the rear portion of a vehicle and often configured as so-called combination lamps. In such a combination lamp, a plurality of lamps having different functions are installed inside a single lamp body. In particular, a typical combination lamp is a tail lamp, and it includes a stop lamp that lights when the driver steps on the brake, a backup lamp that lights when the vehicle backs up, and a turn signal lamp that is lighted when the vehicle changes the direction.

Typically, in a rear combination lamp, a plurality of lamp chambers are demarcated and formed by partitions provided inside a single lamp body, and function lamps are configured within each lamp chamber. In a rear combination lamp with such a structure, partitions are formed from an opaque material and normally integrated with resin configuring the lamp body, thus ensuring that light emitted from one function lamp demarcated and formed inside the lamp body does not leak to another function lamp region.

In a rear combination lamp, it is preferable that a wide area be given to a tail lamp in order to increase the tail lamp visibility. Nonetheless, in such a tail lamp, a part of the tail lamp is designed to provide higher light intensity than the other parts when the brake of the vehicle is operated so that such part functions as a stop lamp. In the case of such a rear combination lamp, partitions as described above are necessary in order to demarcate the stop lamp within the tail lamp. Consequently, when only the tail lamp is lit, the light-shielding partitions tend to become visible darkly. This lowers the visibility of the lit tail lamp and causes a problem in regards to the lamp's exterior appearance from the standpoint of styling.

In the lamp disclosed in the Japanese Patent Application Laid-Open (Kokai) No. 2000-231806, the inner lens has a circular opening, so that the depth direction inside the lamp chamber appears considerably different at the lamp central portion formed by the opening and at the remaining lamp peripheral portion, resulting in that the lamp has a three-dimensional appearance. In particular, a circular rib that extends in the longitudinal direction is formed on the opening rim of the opening of the inner lens, so that the rib differentiates the lamp central portion from the remaining lamp peripheral portion.

In the lamp of the above-described Japanese Patent Laid-Open Publication No. 2000-231806, the circular rib provided in the inner lens demarcates the lamp central portion from the peripheral portion. Consequently, the circular rib appears darkly visible when the lamp is viewed from the outside. In particular, since the side surface of the circular rib appears wide when the lamp is viewed from the side, the area of the darkly visible region becomes larger, lowering the visibility of the lamp. For this reason, if the inner lens of the Japanese Patent Laid-Open Publication No. 2000-231806 was applied to a rear combination lamp as described above in order to demarcate the stop lamp within the tail lamp, the darkly visible area caused by the circular rib of the inner lens would become extremely large when the tail lamp is lit, and this lowers the visibility of the tail lamp and causes problems from the lamp styling standpoint.

### BRIEF SUMMARY OF THE INVENTION

Accordingly, the object of the present invention is to provide a vehicular lamp that is free of deterioration of the external appearance caused by the darkly visible partition that defines a lamp chamber and further has an increased visibility.

The above object is accomplished by a unique structure of the present invention for a vehicular lamp, and the vehicular lamp of the present invention comprises a lamp body, an outer lens that is mounted on the front opening of the lamp body and thus defines a lamp chamber, a partition that divides the lamp chamber into a plurality of regions, a light source disposed in at least one of the divided regions, an inner lens that covers at least a part of the partition, and a light-guiding means for guiding a part of light emitted from the light source into the inner lens.

In the lamp of the present invention, the partition is provided with a window portion which allows light to pass through between the adjacent regions, so that a part of the light emitted from the light source passes through the window portion and radiates to the adjacent region. It is preferable that the inner lens cover the window portion, and lens steps be formed in the region that covers the window portion.

In the vehicular lamp of the present invention, it is preferable that light emitted from the light source and guided to the inner lens by the light-guiding means be radiated from the surface of the inner lens, and a part of light emitted from the light source that passes through the window portion be reflected by the adjacent region and radiated forward. Furthermore, the inner lens may cover a region in which the light source is disposed, and it is preferable that a part of the light emitted from the light source in a region that covers the single region be radiated forward via the inner lens. In cases where the inner lens does not cover one region, a part of the light emitted from the light source is radiated forward without passing through the inner lens.

According to the present invention, the inner lens that covers the partition is brought into a lit state by the light that is from the light source and guided to radiate from the surface of the inner lens. As a result, the partition does not appear dark and the lamp becomes brightly lit, thus improving the visibility of the lamp with an increased styling effect.

Furthermore, in the present invention, since a part of the light from the light source passes through the window portion of the partition to radiate to the adjacent region and is subsequently reflected so that the lamp becomes luminescent, the brightness of the lamp increases further, and its visibility improves even further. The different lit states in a plurality of regions inside the lamp body are blended together to form a lamp that has a novel exterior appearance.

### BRIEF DESCRIPTION OF THE SEVERAL VIEWS OF THE DRAWINGS

FIG. 1 is a perspective view of the vehicular lamp, a rear combination lamp, according to one embodiment of the present invention;

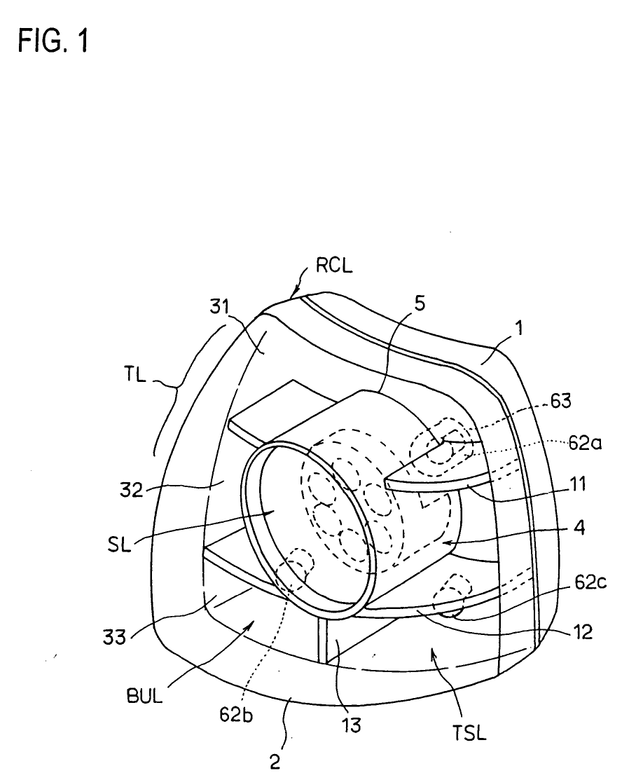

FIG. 2 is a front elevational view of the lamp of FIG. 1;

FIG. 3 is a cross-sectional view taken along the line 3-3 in FIG. 2;

FIG. 4 is a cross-sectional view taken along the line 4-4 in FIG. 2; and

FIG. 5 shows the lamp of FIG. 1 disassembled.

### DETAILED DESCRIPTION OF THE INVENTION

The present invention will now be described with reference to the accompanying drawings.

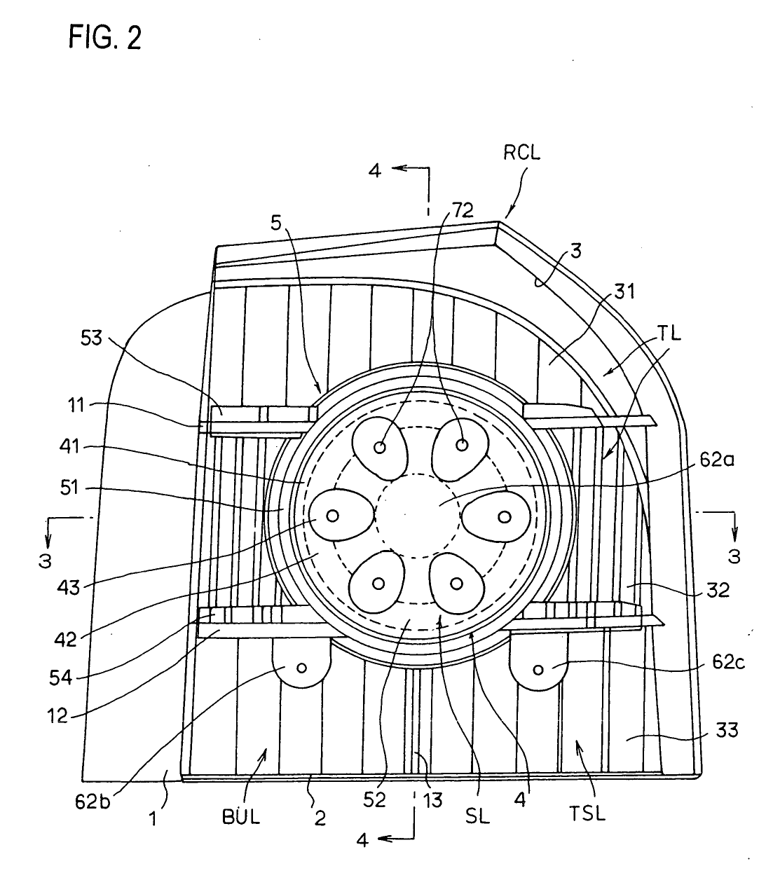

The rear combination lamp RCL is mounted on the right-hand rear portion of a vehicle, and it has a lamp chamber 3 configured inside the rear combination lamp RCL using a lamp body 1 and an outer lens 2 which is attached to the front opening of the lamp body 1. In the lamp body 1, a pair of upper and lower lateral partitions 11 and 12 are formed so that these partitions demarcate a high-level region 31, an intermediate-level region 32, and a lower-level region 33, each extending in the lateral direction (horizontal direction) within the lamp chamber 3 as seen from FIG. 2. In addition, a vertical partition (perpendicular partition) 13 is formed in the lower-level region 33 at the center with reference to the right-left direction, thus forming lower right and lower left regions in the lower-level region 33. A turn signal lamp TSL and a backup lamp BUL are respectively formed in the lower right and left regions defined by the lower lateral partition 12 and the vertical partition 13.

Inside the lamp body 1, a cylindrical partition 4 that has a cylindrical shape is provided substantially at the center of the intermediate-level region 32, and it is disposed so that its cylinder axis coincides with the optical axis of the lamp. The cylindrical partition 4 is integrally formed with an inner lens 5 which will be described below, and the inside of the cylindrical partition 4 is configured as a stop lamp SL that serves also as a tail lamp.

Integrated with the cylindrical partition 4 are a circumferential wall portion 41 and a circular reflector portion 42; and a plurality of (in the shown embodiment, six) small reflectors 43 are circularly disposed within the cylindrical circumferential wall portion 41. The small reflectors 43 are in a shape closely resembling a paraboloid of revolution; and a bottom aperture 44, in which an LED described below is mounted, is opened in the bottom of each one of the small reflectors 43. At the rear end of the circumferential wall portion 41, an upper-half circumferential portion, namely, side and upper portion regions of the circumferential wall portion 41, is cut out, thus forming a window portion 45. The window portion 45 allows the right and left regions of the intermediate-level region 32 and the upper-level region 31 to establish a communication with the inside of the cylindrical partition 4, so that light can pass therethrough. In addition, the surfaces of the circumferential wall portion 41 and the circular reflector portion 42 of the cylindrical partition 4 are aluminized.

The inner surface of the lamp body 1 is also aluminized to serve as a reflector, and the surfaces of the pair of lateral partitions 11 and 12 and vertical partition 13 are also aluminized.

In the shown embodiment, in order to increase the novelty of the styling of the rear combination lamp RCL, the intermediate-level region 32 surrounded by the pair of lateral partitions 11 and 12 is, as best seen from FIG. 2, formed with a vertically striped pattern comprising stepped surfaces of smaller lateral pitches, and the upper-level region 31 and the lower-level region 33 are formed with a vertically striped pattern comprising stepped surfaces of larger lateral pitches whose pitch dimension is somewhat larger than that of the intermediate-level region 32.

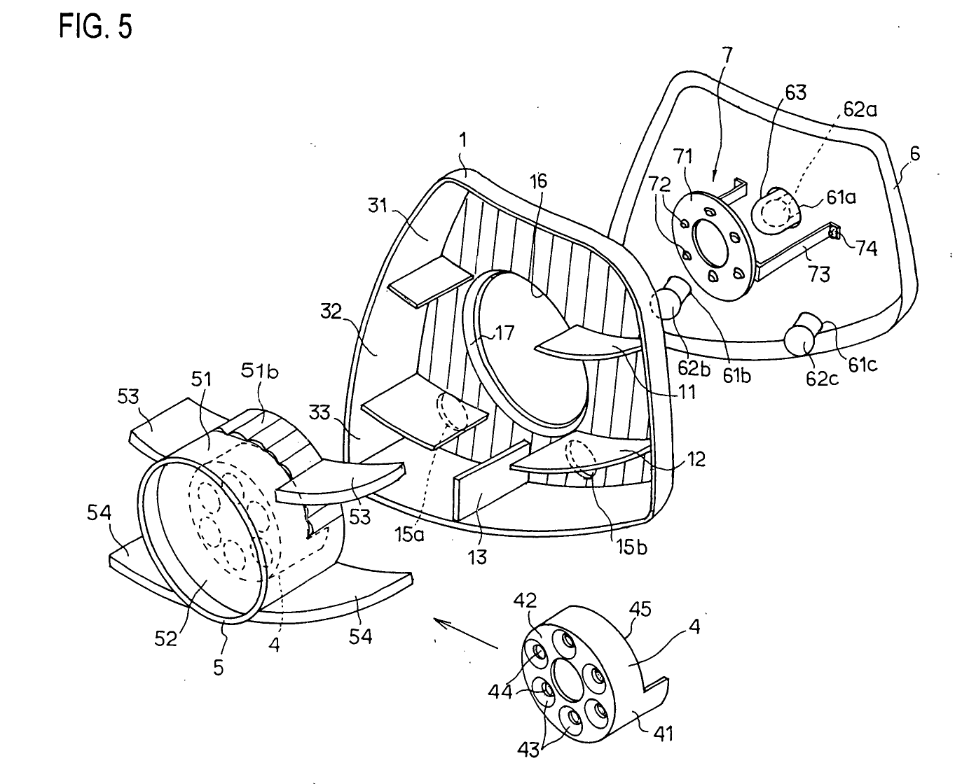

Bulb insertion holes 15a and 15b are, as best seen from FIG. 5, formed in the back wall of the lamp body 1 so that they are respectively in the regions of the backup lamp BUL and the turn signal lamp TSL. A light source insertion hole 16 is formed in the back wall of the lamp body 1 so that it is in the region of the stop lamp SL. The light source insertion hole 16 has a round shape with a diameter somewhat larger than the cylindrical partition 4. A back cover 6 which covers the light source insertion hole 16 and two bulb insertion holes 15a and 15b is mounted on the back of the lamp body 1 by screws or the like (not shown). At least a part of the inner surface of the back cover 6, in particular, the region facing the light surface insertion hole 16, is aluminized in the same manner as the lamp body 1 so that it functions as a reflector.

Bulb sockets 61a, 61b and 61c are respectively formed integrally on the back cover 6 so that they are at the center and right and left locations in the lower side. A tail lamp bulb 62a is disposed in the center bulb socket 61a, and a backup bulb 62b and a turn signal bulb 62c are disposed in the right and left bulb sockets 61b and 61c, respectively. The tail lamp bulb 62a is covered by a red cap 63, thus radiating red light. Once the back cover 6 is mounted on the back of the lamp body 1, the tail lamp bulb 62a is positioned inside the stop lamp SL through the light source insertion hole 16, the backup bulb 62b is inside the backup lamp BUL through the bulb insertion hole 15a, and the turn signal bulb 62c is inside the turn signal lamp TSL through the bulb insertion hole 15b.

Provided within the cylindrical partition 4 of the stop lamp SL is an LED structure body 7, and six LEDs (light-emitting diodes) 72 serving as the stop lamp light source are provided on this LED structure body 7. The LED structure body 7 is provided with a printed board 71 that has a circular shape corresponding to the circular reflector portion 42 of the cylindrical partition 4, and the six LEDs 72 are circularly mounted on the circular printed board 71 so that they match with the six small reflectors 43 of the circular reflector portion 42. The printed board 71 is fixed by a stem 73 to the back cover 6 using screws 74, so that each LED 72 is inside the bottom apertures 44 of the corresponding small reflector 43 when the back cover 6 is mounted on the lamp body 1.

Furthermore, a transparent and colorless inner lens 5 made of resin is disposed in the lamp body 1 so that it covers the region of the stop lamp SL as described above. The inner lens 5 is comprised of a cylindrical lens portion 51, a round-shaped lens portion 52, and a pair of upper and lower lateral extended lens portions 53 and 54, which are integrally formed into a single body. The cylindrical lens portion 51 is fitted on the outer side of the cylindrical partition 4 to cover the region that includes the peripheral surface of the cylindrical partition 4 up to the window portion 45 of the cylindrical partition 4. The round-shaped lens portion 52 is formed on the front end of the cylindrical lens portion 51 and covers the front surface of the stop lamp SL. The upper and lower lateral extended lens portions 53 and 54 project to the right and left from the side surfaces of the cylindrical lens portion 51 and cover at least the front end portions of the pair of lateral partitions 11 and 12.

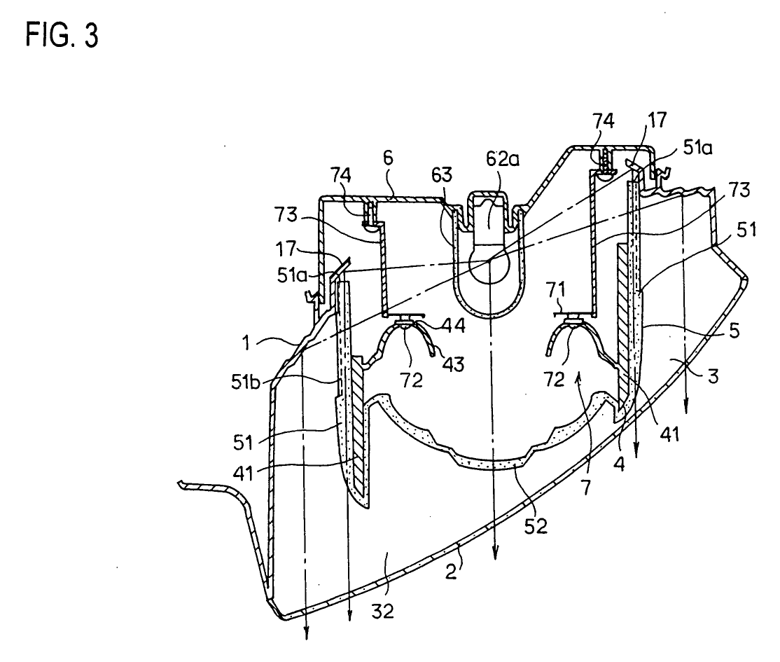

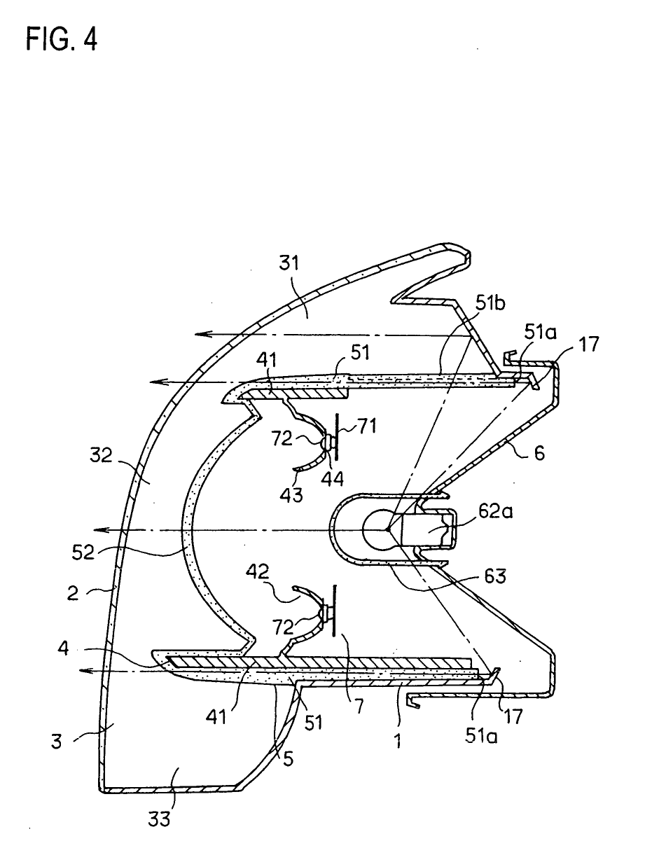

By way of mounting the inner lens 5 to the lamp body 1 via fitting, screws or the like, the cylindrical partition 4 integrally formed with the cylindrical lens portion 51 of the inner lens 5 is mounted on the lamp body 1. As shown in FIGS. 3 and 4, a space is secured in the cylindrical lens portion 51 between the rear end surface 51a and a light-guiding reflector portion 17 that is a part of the inner surface of the lamp body 1. Moreover, the surface contour of the light-guiding reflector portion 17 is formed in such a profile that a part of the light emitted from the tail bulb 62a is reflected to become incident to the rear end surface 51a of the cylindrical lens portion 51. In addition, a lens step 51b is formed on the cylindrical lens portion 51 so as to cover the window portion 45 of the cylindrical partition 4. In other words, a plurality of, for example, cylindrical lens steps and fish-eye lens steps are formed on the cylindrical lens portion 51.

The rear combination lamp RCL of the embodiment of the present invention is structured as described above; and in this rear combination lamp RCL, the bulbs 62a, 62b and 62c are attached to the bulb sockets 61a, 61b and 61c of the back cover 6, respectively; and the back cover 6 is mounted on the back of the lamp body 1 using screws or the like. When the back cover 6 is mounted on the back of the lamp body 1, the bulb 62a is positioned inside the lamp body 1 through the light source insertion hole 16, and the bulbs 62b and 62c are positioned inside the lamp body 1 through the bulb insertion holes 15a and 15b, so that the bulbs 62a, 62b and 62c are respectively set at predetermined positions in the lamps SL, BUL and TSL. In addition, the printed board 71 provided on the back cover 6 by the stem 73 is positioned inside the light source insertion hole 16, and each LED 72 on the printed board 71 is disposed inside the corresponding bottom aperture 44 of each one of the small reflectors 43 that are integral with the cylindrical partition 4.

When the rear combination lamp RCL is unlit, outside light entering the lamp body 1 through the outer lens 2 is reflected by the reflective surface, which is formed on the inner surface of the lamp body 1 and functions as a reflector, and by the aluminized surface, which is formed on the cylindrical partition 4 that is inside the inner lens 5; and such light is further reflected by the surfaces of the upper and lower lateral partitions 11 and 12 which are covered by the lateral extended lens portions 53 and 54 of the inner lens 5. Therefore, these regions present a bright external appearance and also present a crystal appearance created by the silver color brought by the aluminization and by the transparent color of the inner lens 5. As a result, the lamp looks to have an increased styling effect. Furthermore, the styling effect of the lamp's external appearance is also increased by a striped reflective effect caused by the stepped surfaces formed on the reflective (aluminized) surface in each of the regions 31, 32 and 33.

When the backup lamp BUL is lit, white light from the backup bulb 62b is reflected by the reflector (reflective surface) of the inner surface of the lamp body 1 and emitted outward through the outer lens 2. Likewise, amber light from the turn signal bulb 62c is reflected by the reflector (reflective surface) of the lamp body 1 and emitted outward through the outer lens 2 when the turn signal lamp TSL is lit. Since the lamp chambers are demarcated by the lower-level lateral partition 12 and the vertical partition 13 inside the lamp body 1, when the lamps BUL and TSL are lit, these partitions ensure that light emitted from the lamp bulbs is prevented from leaking into the adjacent (next) lamp chamber.

When the stop lamp SL is lit, the six LEDs 72 emit light. Red light from each LED 72 is emitted from the interior of the small reflectors 44 through the respective bottom apertures 44 and reflected by the reflective surfaces of the small reflectors 44. The red light then passes through the round-shaped lens portion 52 of the inner lens 5 and is emitted outward via the outer lens 2.

Furthermore, when the tail lamp TL is lit, light from the tail bulb 62a advances forward from the circumferential wall portion 41 of the cylindrical partition 4 and then passes through the round-shaped lens portion 52 of the inner lens 5 and is eventually emitted outward through the outer lens 2. Thus, the interior of the cylindrical partition 51 is lit brightly. In addition, as best seen from FIG. 4, a part of the light radiated rearward from the tail bulb 62a is reflected by the reflector formed in the inner surface of the back cover 6; and such light then passes through the round-shaped lens portion 52 and emitted outside through the outer lens 2 together with the light directly emitted from the tail bulb 62a.

At the same time, a part of the light emitted upward from the tail bulb 62a (see FIG. 4) and a part of the light emitted rightward and leftward from the tail bulb 62a (see FIG. 3) pass through the window portion 45 formed in the circumferential wall portion 41 of the cylindrical partition 4. Such light passes through the cylindrical lens portion 51 of the inner lens 5 and is emitted to the regions adjacent to the upper, right and left sides of the cylindrical partition 4. The reflector on the inner surface of the lamp body in these adjacent regions reflects the light forward, letting the light be emitted outside the lamp through the outer lens 2.

Thus, the entire tail lamp TL is bought into a lit state; in other words, the interior of the cylindrical partition 4 within the lamp body 1, the intermediate-level region 32 on both right and left sides of the cylindrical partition 4, and the high-level region 31 on the upper side of the cylindrical partition 4, all become lit. In this situation, light passing through the window portion 45 of the cylindrical partition 4 is refracted by the lens step 51b provided on the cylindrical lens portion 51. Therefore, light in a unique luminescent state is emitted from the outer lens 2 in cooperation with the reflective characteristics of the stepped surfaces on the reflectors in adjacent regions, which achieves novelty in the lit lamp.

Furthermore, a part of the light emitted upwardly in the rear direction, as well as rightward and leftward, from the tail bulb 62a is reflected by the light-guiding reflector 17 and then guided to the inside of the cylindrical lens portion 51 from the rear end surface 51a of the cylindrical lens portion 51 of the inner lens 5. Moreover, a part of the guided light is guided from the cylindrical lens portion 51 up to the lateral extended lens portions 53 and 54. Accordingly, the cylindrical lens portion 51 and the lateral extended lens portions 53 and 54 guide the light, which is emitted from the surfaces of the cylindrical lens portion 51 and the lateral extended lens portions 53 and 54, and then emitted out through the outer lens 2. Thus, the cylindrical lens portion 51 and the lateral extended lens portions 53 and 54 are brought into a lit state, and the guided light is emitted from the surfaces of the cylindrical lens portion 51 and lateral extended lens portions 53 and 54 and then emitted outside through the outer lens 2. More specifically, the cylindrical lens portion 51 of the inner lens 5 covers the circumferential wall portion 41 of the cylindrical partition 4, and the lateral extended lens portions 53 and 54 of the inner lens 5 cover the pair of lateral partitions 11 and 12; accordingly, light guided by these lens portions 51, 53 and 54 is also reflected by the surfaces of the circumferential wall portion 41 and lateral partitions 11 and 12. Consequently, the amount of light emitted from each lens portion is increased such that each presents a bright external appearance. The lamp thus also appears bright when viewed from the side, because of the light guided and emitted from the peripheral surface of the cylindrical lens portion 51. Therefore, it is possible to avoid the dark appearance of partitions of the lamp body 1 when the tail lamp TL is lit, further improving the visibility and presenting a splendid appearance. Therefore, the partitions of the lamp body 1 are prevented from having dark appearance when the tail lamp TL is lit, and this further improves the visibility and provides a splendid appearance.

As described above, in the rear combination lamp RCL of the shown embodiment of the present invention, when the tail lamp TL (or the tail bulb 62a) is lit, the interior region of the cylindrical partition 4 is brought into a lit state by the light directly emitted from the tail bulb 62a, the high-level region 31 and the intermediate-level region 32 on the outer side of the cylindrical partition 4 are brought into a lit state by a part of the light emitted from the tail bulb 62a and is reflected by the reflector (aluminized surfaces), and the cylindrical partition 4 and the lateral partition 11 and 12 are brought into a lit state by a part of the light emitted from the tail bulb 62a and is guided through the inner lens 5. In other words, a lit state is created by a combination of three different modes of lit states. Therefore, the rear combination lamp RCL is brightly lit over the wide region, and the tail lamp TL has improved and increased visibility. In addition, since the different lit states of a plurality of regions of the tail lamp TL blend together to form one tail lamp, the lamp has novel styling designs as a whole.

The shape of the cylindrical partition and the inner lens that covers the cylindrical partition is not limited to the round shape as described in the shown embodiment; and an elliptical shape, polygonal shape or the like can be employed depending on the styling required by the lamp. In the shown embodiment, the interior region of the cylindrical partition 4 is covered by the cylindrical lens portion 52 of the inner lens 5, and light from the tail bulb 62a passes through the cylindrical lens portion 52 and is then radiated forward; however, the cylindrical lens portion 52 can be omitted; and when the cylindrical lens portion 52 is not used, light from the tail bulb 62a is emitted directly forward and to the outside through the outer lens 2. In this case, a desired light distribution characteristic can be obtained from lens steps formed on the outer lens 2.

In the above embodiment, the present invention is described on a rear combination lamp in which the stop lamp is demarcated by a cylindrical partition. However, it is evident that the present invention is applicable to any type of vehicular lamp that has a configuration in which a plurality of lamps are demarcated by partitions and integrated inside a lamp body by way of covering the partitions with an inner lens and allowing light to be guided to the inner lens.

1. A vehicular lamp comprising:
a lamp body;
an outer lens mounted on a front opening of the lamp body to define a lamp chamber;
a partition dividing the lamp chamber into a plurality of regions;
a light source disposed in at least one of the plurality of regions;
an inner lens covering at least a part of the partition; and
a light-guiding means for guiding a part of light emitted from the light source into the inner lens.

2. The vehicular lamp according to claim 1, wherein the partition is provided with a window portion, which allows light to pass through, between adjacent regions, so that part of light emitted from the light source passes through the window portion and radiates to adjacent regions.

3. The vehicular lamp according to claim 2, wherein the inner lens covers the window portion, and lens steps are formed in a region that covers the window portion.

4. The vehicular lamp according to claim 2 or 3, wherein light emitted from the light source and guided to the inner lens by the light-guiding means is radiated from a surface of the inner lens, and light emitted from the light source and passes through the window portion is reflected by the adjacent regions and radiated forward.

5. The vehicular lamp according to claim 1 or 2, wherein the inner lens covers one of the regions in which the light source is disposed and radiates forward therethrough a part of light emitted from the light source.

6. The vehicular lamp according to claim 3, wherein the inner lens covers one of the regions in which the light source is disposed and radiates forward therethrough a part of light emitted from the light source.

7. The vehicular lamp according to claim 4, wherein the inner lens covers one of the regions in which the light source is disposed and radiates forward therethrough a part of light emitted from the light source.
